(19) United States
(12) Patent Application Publication
(10) Pub. No.: US 2014/0025590 A1
(43) Pub. Date: Jan. 23, 2014

(54) System and method of operation for an automated process of IP search and submission to the USPTO

(71) Applicants: William Petrow, Charlotte, VT (US); John Edward Cronin, Jericho, VT (US)

(72) Inventors: William Petrow, Charlotte, VT (US); John Edward Cronin, Jericho, VT (US)

(21) Appl. No.: 13/938,153

(22) Filed: Jul. 9, 2013

Related U.S. Application Data
(60) Provisional application No. 61/741,132, filed on Jul. 10, 2012.

(51) Int. Cl. G06Q 50/18; G06F 17/30

(52) U.S. Cl. CPC G06Q 50/184; G06F 17/3053
USPC 705/310

(57) ABSTRACT

Pre-issuance submissions may be provided by any third party for addition to the record of a patent application. In addition, the post-grant review proceeding allows a third party to request the USPTO to review a recently issued patent based upon almost any ground of invalidity. The embodiments disclosed herein relate to an automated process of IP search and submissions to the. United States Patent and Trademark Office (USPTO) for pre-issuance submissions and post-grant review. The invention provides a new and efficient means of searching for patents related to a third-parties' business interests, and submitting references to the USPTO by an automated means.

### PRIORITY CLAIM

This application claims the benefit of U.S. Provisional Application No. 61/741,132, filed Jul. 10, 2012.

### TECHNICAL FIELD

Various inventive embodiments disclosed herein relate generally to processes of pre-issuance submissions and post-grant review at the USPTO. In particular, embodiments disclosed herein relate to an automated process of IP search and submissions to the United States Patent and Trademark Office (USPTO) for pre-issuance submissions and post-grant review.

### BACKGROUND

Recent changes in the U.S. patent law, i.e. the Leahy-Smith America Invents Act (AIA), support increased third party involvement through pre-issuance submissions to the files of pending patent applications, and by means of a new post-grant review proceeding.

According to the AIA, pre-issuance submissions may be provided by any third party for addition to the record of a patent application, and may include any patent, published patent application or other published material of potential relevance to the examination of the application. In addition, the new post-grant review proceeding allows a third party to request the USPTO to review a recently issued patent based upon almost any ground of invalidity.

These interested third parties could include business competitors, technology developers, legal professionals and others, whose business or activities would be affected if a particular patent application was granted. Therefore, in the context of this disclosure the term “business” is understood to mean any third party interest including any technology, market, legal, commercial, trade, manufacturing or other intellectual property (IP) interest.

Pre-issuance submissions may present for consideration to the patent examiner numerous potential new grounds of invalidity, by a new means that can be described as a crowd-sourcing approach. Consequently, pre-issuance submissions may potentially drive down average pendency time, possibly increasing patent office efficiency and improving overall patent quality in the long run.

However, in order for the pre-issuance process to work effectively, third parties must first be aware that a patent application that is of interest to them has published. For example, applications of interest may be those filed by a specific competitor, or alternatively, those applications containing specific subject matter, or both. And similarly, the post-grant review process also requires awareness by third parties that a patent of interest has issued.

This raises two issues: First, third-parties must understand how their business interests relate to the IP described in these newly issued patents and recently published patent applications. For example, if a business interest of third-party is cost reduction—the IP related to cost reduction for a specific product may be: “thin wall plastic extrusions”. Secondly, third-parties must also be aware of when business-relevant patents/applications issue/publish in a timely way. This is especially true in that a pre-issuance submission must be prepared within the six-month time period set by the AIA, and a petition for a post-grant review must be filed within 9 months of grant of the patent or issuance of a reissued patent.

However, the process of finding patents and patent applications that are relevant to specific search parameters is quite often a time intensive and laborious task. Typically a patent search is performed by a user submitting search terms to a search engine with access to a patent database, most likely over the internet or other local networks. These search terms are often boolean expressions that describe the search parameters in a specific codified format. Typical search engines provide results based on the search terms the user has manually entered, although some level of automation is currently available. For example, a few search engines will automatically search synonyms of the terms entered by the user.

As a result, the current means of searching patent applications related to specific search parameters is labor intensive and of limited value as it may or may not provide results that accurately relate to the third-party business interests being searched.

Therefore, what is needed is a new and efficient means of searching for patents related to a third-parties' business interests.

In addition, the timeliness of the patent and/or application search is extremely important to provide third parties with sufficient time to prepare a pre-issuance submissions and/or petitions for post-grant review; therefore, what is further needed is a new and efficient means to alert third-parties that a patent/application of interest has published in a timely way.

However even if a patent or application search is successful, the search may uncover an unmanageably large number of new patents and applications, with inconsistent results in that some of these patents/applications may not be as related to the third-party's business as others. And still further, even among highly relevant patents/applications the content of some patents/applications may be weak, as they serve only narrow interests in a limited number of small markets, while others may be relatively strong, because they are widely applicable in large markets or a large number of markets.

Therefore what is also needed is a means of grading the relative importance of a particular patent or patent application to the business interests of specific third-parties.

Once a third-party has identified a target patent or application that reads on its business interests, that third-party may choose to find references for a pre-issuance submission or for a petition for post-grant review. These references may already be known, to the submitter, or they may be searched for. Standard means of searching patents and applications are well known, as described earlier. Other references may include technical white papers, material from trade journals and other publications. As a result, a large number of references may be gathered for the multiple patents and/or applications that read on a third party's business. These references will need to be properly formatted for submission, a potentially challenging task given the potentially large numbers of these documents.

Therefore what is also needed is an automated means of submission formatting, such that these numerous references may be properly presented to the PTO for pre-issuance submission or a petition for post-grant review.

### BRIEF DESCRIPTION OF THE DRAWINGS

Various inventive embodiments disclosed herein, both as to its organization and manner of operation, together with further objectives and advantages, may be best understood by reference to the following description, taken in connection with the accompanying drawings as set forth below:

FIG. 1 illustrates a System for Automated IP Search and Submission 100;

FIG. 2 illustrates a Process for Automated IP Submissions 200;

FIG. 3 illustrates a Process for Grading IP Submissions 300;

FIG. 4 illustrates a Process for Searching References and Providing Submissions 400;

### DETAILED DESCRIPTION

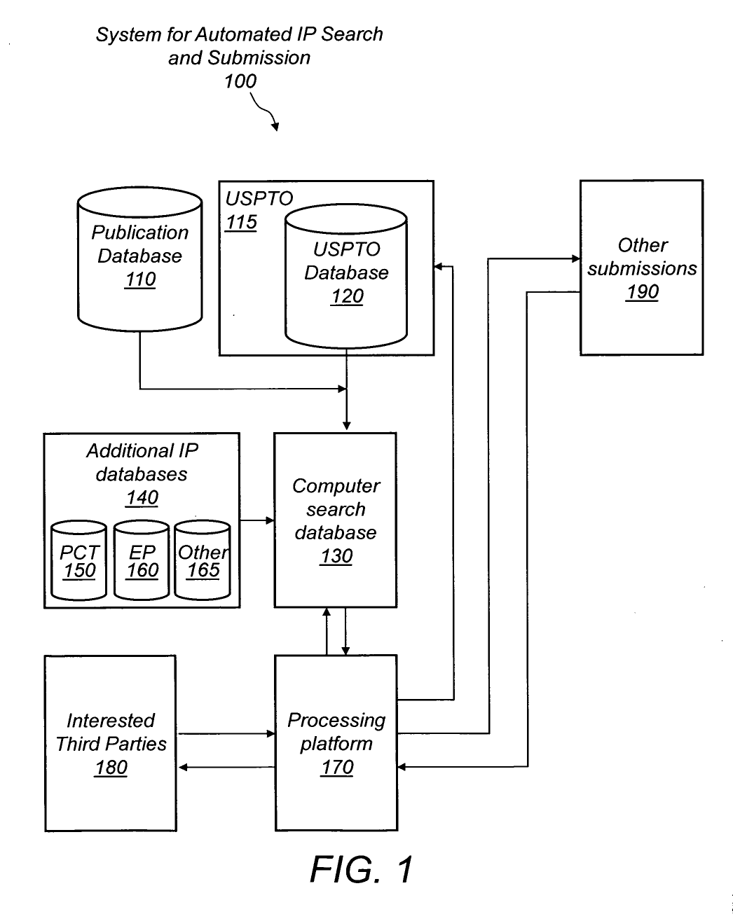

FIG. 1 illustrates a system for automated IP search and submission 100. The system of the invention includes the following elements: Publication database 110; USPTO 115, further including USPTO database 120; computer search database 130; other patent databases 140, further containing PCT 150 database, EP 160 database, and other 165 database; processing platform 170; interested third parties 180; and other submissions 190.

Wherein, processing platform 170 is a standard personal computer or alternatively a specialized computer operated by a user to search for patents, patent applications and other information by means of a computer search database 130 that is connected to it by a communication means (not shown) such as, for example, the internet or a private intranet. Further, where computer search database 130 contains search algorithms and databases running on a computer, such as a network computer host (not shown), that allows it to search among the patent, patent application and publication data stored in USPTO 115, additional patent databases 140, and various publication information from publication database 110, which contains an online source of intellectual property publications such as IP.COM®. Additional patent databases 140 further contain the patents and patent applications of their respective jurisdictions, PCT 150, EP 160 and Other 165, where Other 165 may contain the patent information of any other jurisdiction. Publication database 110, USPTO 115 and additional patent databases 140 are all in data communication with computer search database 130 via a communication means (not shown) such as, for example, the internet or a private intranet. Examples of computer search database 130 include Thomson Reuters “Thomson Innovation” and LexisNexis®. Further wherein, processing platform 170 is in data communication with interested third parties 180 who provide search parameter information, by. means of a network connection such as the internet or a private intranet.

In practice, interested third parties 180 provide search parameters (not shown) to processing platform 170, reflecting their business interests, such that the user of processing platform 170 may search for patents and patent applications which may pertain to their business from the data contained in Publication database 110, USPTO 115 and additional patent databases 140 via computer search database 130. Additionally, other submissions 190, denote the patent and publication information that may be provided to processing platform 170, by others such a crowdsourcing intellectual property search websites such as Article One Partners® (AOP), through communication means (not shown), thereby providing still another source of information to interested third parties 180.

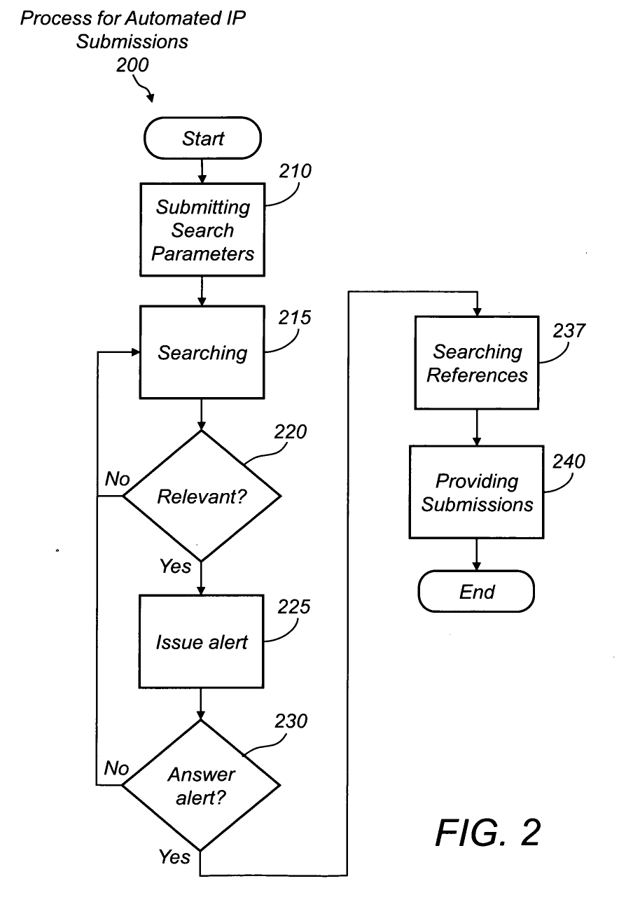

FIG. 2 illustrates a flow diagram of a process for automated pre-issuance submissions 200. Process 200 may include, but is not limited to, the following steps:

At a step 210, (submitting search parameters) interested third party 180, i.e. a third party interested in identifying new competitive patent filings, identifies search parameters that relate to its business interests, including assignee names, inventor names, keywords, IPC or US classification codes, or other IP search delimiters, and communicates this information to processing platform 170.

At a step 215, (searching) newly issued U.S. patents and/or recently published U.S. patent applications are searched, automatically and periodically, using computer search database 130 via processing platform 170 according to search parameters defined in step 210 to detect competitive business-relevant new filing activity over time. Wherein using computer search database 130 is in data communication with USPTO database 120.

At decision step 220, (relevant?) relevant competitive filing activity is verified to have occurred, if newly published patent applications are found according to the search performed in step 215. If yes, method 200 proceeds to step 225. However, if no, then method 200 returns to step 215.

At step 225, (issue alert) an alert is issued to interested third party 180 via a communication means (not shown) that a patent application of interest has published, i.e. a “target application”, as defined by the search parameters described in step 210, creating awareness of competitive patenting activity.

At a decision step 230, (answer alert?) interested third party 180 decides to pursue a pre-issuance submission for the patent application(s) found according to the search performed in step 215. If yes, method 200 proceeds to step 235. However, if no, then method 200 returns to step 215.

At a step 235, (searching references) suitable relevant references for consideration by the USPTO for pre-issuance submission or post-grant review are identified in a number of ways. Previously published patents, patent applications and other publications of potential relevance to the target application validity are searched in an automated fashion using computer search database 130 via processing platform 170 according to search parameters defined in step 210, or additional search parameters provided by interested third party 180. Or else, other submissions 190 may be provided to processing platform 170, using well-known techniques of reference research, such as library research.

At a step 240, (providing submissions) the pre-issuance submission and/or post-grant review references found in step 235 are provided to interested third party 180, for review, prior to submission to the PTO. Method 200 ends.

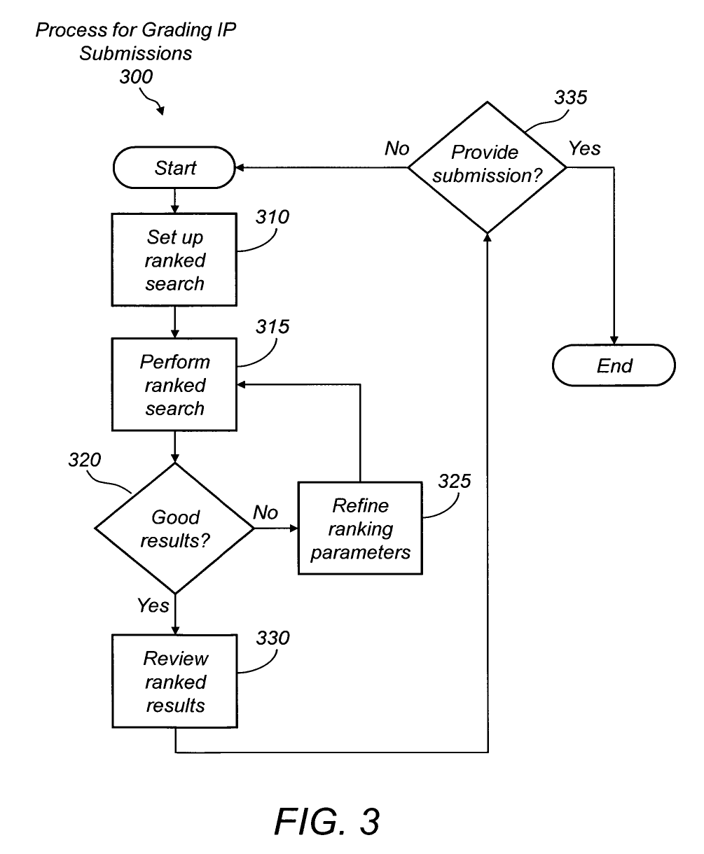

FIG. 3 illustrates a flow diagram of a process for grading IP references 300 for pre-issuance submission or post-grant review. Process 300 may include, but is not limited to, the following steps:

At a step 310, (set up ranked search) interested third party 180, identifies the search parameters that relate to the target application including assignee names, inventor names, keywords, IPC or US classification codes, or other IP search delimiters—that address the technology, business, market and other IP issues pertaining to the target application and communicates these search parameter to processing platform 170. After which, the user of processing platform 170 creates a plurality of search strategies from the search parameters, as follows: These strategies are ordered in graduated levels of specificity—corresponding to increasing relevancy, such that a ranking of relevance may be inferred i.e. the greater the number of search parameters found in a given patent or patent application the higher that document will be ranked.

At a step 315, (perform ranked search) a search for references pre-submission or post-grant review is performed based on the search parameters of step 310. When returning to this step from step 325—iterate search.

At a decision step 320, (good results?) the results of the ranked search performed at step 315, are reviewed with interested third party 180. Proceed to next step if interested third party 180 decides the results are good for each search rank. If yes, method 300 proceeds to step 330. However, if no, then method 300 proceeds to step 325.

At a step 325, (refine ranking parameters) the ranked search parameters defined in step 310 are refined as a result of the ranked search.

At a step 330, (review ranked results) interested third party 180 reviews the ranked search result output, in preparation for a decision to submit.

At a decision step 335, (provide submission?) interested third party 180 chooses to provide submissions to the USPTO. If yes, method 300 ends. However, if no, then method 300 returns to step 310. Method 200 ends.

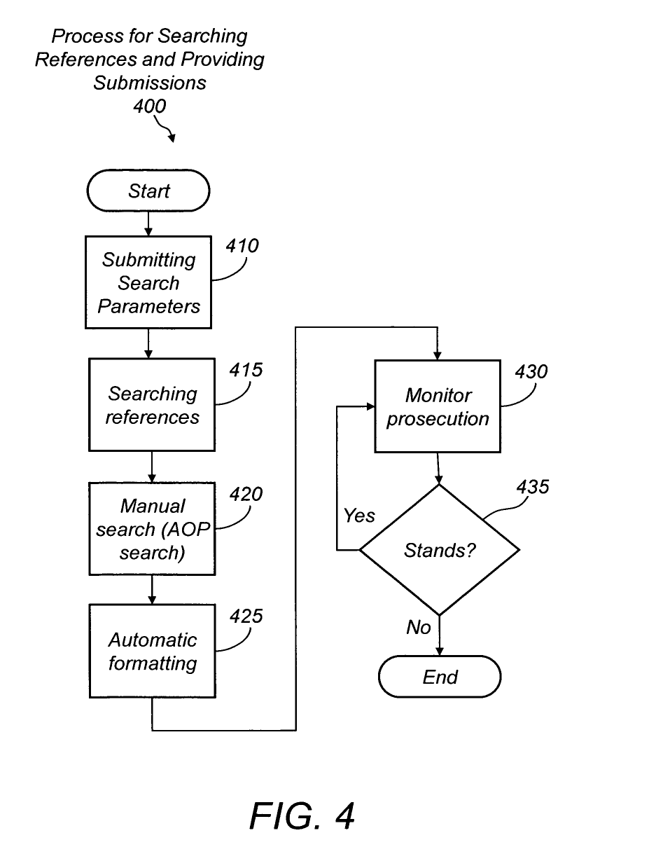

FIG. 4 illustrates a flow diagram of a process for searching references and providing submissions 400 for the purpose of finding references for pre-issuance submissions. Process 400 may include, but is not limited to, the following steps:

At a step 410, (submitting search parameters) interested third party 180, identifies the search parameters that relate to the target application including assignee names, inventor names, keywords, IPC or US classification codes, or other IP search delimiters—that address the technology, business, market and other IP issues pertaining to the target application and communicates these search parameter to processing platform 170. After which, the user of processing platform 170 creates a plurality of search strategies from the search parameters.

At a step 415, (searching references) previously published patents, patent applications and other, publications of potential relevance to the target application are automatically searched using computer search database 130 via processing platform 170 according to search parameters defined in step 410 to find suitable references for pre-issuance submission or post-grant review.

At optional step 420, (manual search) a manual search is conducted to find references for use for pre-issuance submissions submission or post-grant review. Other submissions 190 are a potential source of manual submissions. The manual search may include a variety of approaches including a crowd-sourcing approach, in which the technical community is invited to submit references familiar to them that relate to the target application.

At a step 425, (automatic formatting) the USPTO forms are automatically generated—to create the pre-issuance submission documents or post-grant review petitions, or other USPTO submission documents.

At a step 430, (monitor prosecution) the status of the patent or patent application in question, i.e. the target, is automatically monitored at the USPTO, for example, by using the PAIR system, to determine if the patent application stands

At a decision step 435, (stands?) If the target remains active, e.g. if the application in prosecution stands or the patent is not invalidated, and if interested third party 180 wishes to continue, and if the statutory time period has not elapsed. If yes, method 400 returns to step 430. However, if no, then method 400 ends.

1. A method of operation for automated submissions comprising the steps of:
submitting search parameters to find patent applications of interest for submissions;
searching to find patent applications of interest for submissions;
determining if the patent applications found are relevant;
issuing alert to interested parties if the patent applications found are relevant;
answering alert by interested parties if the patent applications found are relevant;
selecting the specific patent applications of interest which will be candidates for pre-issuance submission;
searching for references for pre-issuance submission or post-grant review, and;
providing for pre-issuance submission or post-grant review to the interested parties or the USPTO.

2. The method of claim 1 wherein, the step of selecting the specific patent applications comprises the further steps of:
setting up ranked search to find patent applications of interest for for pre-issuance submission or post-grant review;
performing a ranked search to find patent applications of interest for for pre-issuance submission or post-grant review;
determining ranked results need refinement ;
reviewing ranked results with the interested parties, and;
providing the specific patent applications of interest which will be candidates for pre-issuance submission or post-grant review submissions.

3. The method of claim 1 wherein, the step of searching for references comprises the further steps of:
submitting search parameters;
performing an automated reference search, and;
optionally providing a manual search.

4. The method of claim 1 wherein, the step of providing for pre-issuance submission or post-grant review comprises the further steps of:
automatically formatting;
monitoring prosecution, and;
continuing to monitor prosecution, if the applications of interest still stands.
